(19) United States
(12) Patent Application Publication
(10) Pub. No.: US 2024/0367895 A1
(43) Pub. Date: Nov. 7, 2024

(54) PORTION CONTAINER MADE OF BIODEGRADABLE FIBER MATERIAL

(71) Applicant: Kiefel GmbH, Freilassing (DE)

(72) Inventors: Bernd Stein, Kirchanschöring (DE); Matthias Hausmann, Unken (AT); Erwin Wabnig, Siegsdorf (DE); Thomas Halletz, Waging am See (DE)

(21) Appl. No.: 17/754,788

(22) PCT Filed: Oct. 1, 2020
(86) PCT No.: PCT/DE2020/000225

§ 371 Date: Jul. 29, 2024

(30) Foreign Application Priority Data
Oct. 14, 2019 (DE) 10 2019 127 556.3

(51) Int. Cl. B65D 85/804; B65D 65/42; B65D 65/46

(52) U.S. Cl. CPC B65D 85/8067; B65D 65/42; B65D 65/466; B65D 2565/387

(57) ABSTRACT

The invention relates to a portioning container (1) made of biodegradable fiber material (11), to a molded fiber system (100), and to a method (200) for manufacturing such portioning containers (1), comprising a receptacle (2) for holding a consumable (G, G′) and a cover (6) for closing the receptacle to produce a sealed volume (V) within the portioning container (1), wherein at least the receptacle (2), preferably also the cover (6), is manufactured from biodegradable fiber material (11) using a molded fiber system (100) by means of a molded fiber process, from a pulp (7, 7a, 7b) as a liquid solution containing the biodegradable fiber material (11), wherein at least the receptacle (2), preferably also the cover (6), is provided with a barrier layer system (8) which has a barrier effect at least against penetration of moisture, water, aromatic substances, flavoring agents, odorants, and/or non-food-grade substances.

### FIELD OF THE INVENTION

The invention relates to a portioning container made of biodegradable fiber material, to a molded fiber system, and to a method for manufacturing such portioning containers.

### BACKGROUND OF THE INVENTION

It is desirable to protect citizens and the environment from plastic pollution. In particular, single-use plastic products such as plastic cutlery, plastic tableware, and packaging materials such as coffee capsules cause large amounts of waste. In this respect, there is an increasing demand for substitute materials for plastic packaging materials and containers which allow these products to be manufactured from recyclable plastics, materials with a lower plastic content, or even from plastic-free materials.

The concept of using natural fibers instead of conventional plastics in extrusion processes has existed at least since the early 1990s; see for example EP 0 447 792 B1. The raw material basis in this case, as in most fiber-processing methods, is pulp. In principle, pulp consists of water, natural fibers, and a binding agent such as industrial starch (potato starch) and has a mushy consistency.

Since consumers are interested in a wide variety of environmentally friendly products of different sizes, shapes, and requirements and do not necessarily demand said products in very large quantities, it would be desirable to have available a manufacturing process for environmentally friendly portioning containers such as beverage concentrates or coffee capsules from natural fibers and to have available a corresponding machine in order to reproducibly manufacture said products (molded parts) effectively, flexibly, and with a high level of quality.

### SUMMARY OF THE INVENTION

The object of the invention is that of providing environmentally friendly portioning containers from natural fibers, a corresponding machine, and a manufacturing process by means of which said portioning containers can be reproducibly manufactured effectively, flexibly, and with a high level of quality.

The object of the invention is achieved by a portioning container comprising a receptacle for holding a consumable and a cover for closing the receptacle to produce a sealed volume within the portioning container, wherein at least the receptacle, preferably also the cover, is manufactured from biodegradable fiber material using a molded fiber system by means of a molded fiber process, in particular a molded fiber process according to the invention as per claim 37, from a pulp as a liquid solution containing the biodegradable fiber material, wherein at least the receptacle, preferably also the cover, is provided with a barrier layer system which has a barrier effect at least against penetration of moisture, water, aromatic substances, flavoring agents, odorants, and/or non-food-grade substances.

The term “portioning container” refers to a closed cavity by means of which a consumable can be prepared, portioned, dosed, brewed, and/or modified in terms of taste. This can occur under external influence (for example, by adding hot or cold water) or by merely releasing the consumable for consumption (for example, as an independent consumption portion or as a dosing container for modifying other consumables already present). Consumables refer to all food or food supplements that can be ingested by humans, animals, or plants through the mouth or nose for their enjoyment. Consumables can in this case be beverages, beverage supplements, concentrates for beverages, substances for brewing processes (for example, coffee powder), spices, spice mixes, instant soups, dietary supplements, bouillon cubes, etc., and may be present in the portioning container in solid, liquid, or powdered form. The receptacle and the cover are components of the portioning container and can be manufactured together or separately from one another. When being manufactured separately or together, they can subsequently be connected or assembled to form the portioning container. This connection can be reversible or it can be a fixed connection that is not intended to be separated. The consumable is preferably dispensed into the receptacle before the cover is attached to the receptacle. Alternatively, the cover could also have a filling opening through which the consumable is dispensed after the receptacle has been closed with the cover. The cover can be attached to the receptacle, for example by gluing with an adhesive, by pressing the cover into the receptacle (preferably both components are manufactured from fiber material), by mechanical connecting means (clamps, clips, etc.), or screwed on by means of threads in the receptacle and the cover, or clipped, clamped, or latched into place by means of grooves, projections, etc.

The term “biodegradable fiber material” refers to fiber materials that are able to decompose under environmental influences such as moisture, temperature, and/or light, with the decomposition process taking place in the short term, for example in a period of days, weeks, or a few months. For the sake of simplicity, the “biodegradable fiber material” is sometimes referred to below just as “fiber material”. In this case, it is preferable that neither the fiber material nor the decomposition products pose an environmental hazard or contamination. Fiber materials that constitute a biodegradable fiber material within the meaning of the present invention are, for example, natural fibers obtained from cellulose, paper, cardboard, wood, grass, plant fibers, sugar cane residues, hemp, etc., or from their components or parts thereof and/or correspondingly recycled material. However, a biodegradable fiber material can also refer to artificially manufactured fibers such as PLA (polylactide), etc., which correspond to the above fiber materials or have their properties. The biodegradable fiber material is preferably compostable. The biodegradable fiber material and the containers manufactured from it are preferably suitable to be introduced into the recovered substance cycle of the German organic waste system and as a resource for biogas plants. The fiber materials and the containers manufactured therefrom are preferably biodegradable in accordance with EU standard EN 13432.

The term “pulp” refers to fluid masses that contain fibers, in this case the biodegradable fiber material. The term “liquid” refers here to the state of aggregation of the pulp, with the liquid pulp comprising the biodegradable fiber material in the form of fibers. The fibers can be present as individual fibers, as a fibrous structure, or as a fiber group made up of several interconnected fibers. The fibers constitute the fiber material, regardless of whether they are in the pulp as individual fibers, as a fibrous structure, or as a group of fibers. The fibers are dissolved in the liquid solution in such a way that they float in the liquid solution with an as equal a concentration as possible regardless of location, for example as a mixture or suspension of liquid solution and fiber material. For this purpose, for example, the pulp can be appropriately temperature-controlled and/or circulated in some embodiments. The pulp preferably has a low consistency, that is, a fiber material content of less than 8%. In one embodiment, a pulp with a biodegradable fiber material content of less than 5%, preferably less than 2%, particularly preferably between 0.5% and 1.0%, is used in the method according to the invention. This small proportion of fiber material can, among other things, prevent clumping of the fiber material in the liquid solution, thus allowing the fiber material to still be molded onto the suction tool with a high level of quality. Although clumped fiber material can be suctioned by the suction tool, it would presumably result in a portioning container with a fluctuating layer thickness, which should if possible be avoided in the production of the portioning containers. In this respect, the proportion of fiber material in the pulp should be small enough to ensure that clumping or interlinking does not occur or occurs only to a negligible extent. The liquid solution can be any solution that is suitable for the molded fiber process. For example, the pulp can be an aqueous solution containing the biodegradable fiber material. An aqueous solution is, among other things, an easy-to-handle solution.

The molded fiber process refers to the process steps that are involved in shaping the portioning container or the components thereof, beginning with the provision of the pulp, the integral molding of the receptacle and/or the cover in the suction tool from the fiber material from the pulp, the pre-pressing of these integrally molded components of the portioning container, the hot-pressing of the receptacle and/or the cover, and optionally the coating of the receptacle and/or the cover with functional layers such as barrier layers, it being possible to apply the coating in the molded fiber process at any location that is suitable for the particular layer to be applied. Using this molded fiber process, the content of liquid solution in the fiber material of the final-shaped portioning container is still small enough that the portioning container is dimensionally stable for all subsequent processes after the final shape has been produced. The individual steps of molding, pre-pressing, and producing the final shape by means of a hot-pressing station (hot-pressing) contribute to this, either individually or together.

The barrier layer system can comprise one or more functional layers that can be used for the portioning container, for example as moisture, water, aroma, fat, oil, acid, odor or taste barriers or as a barrier against gases such as O₂ and N₂, non-food grade substances or any substances that contribute to the perishability of food. Such properties are provided, for example, at least in part, by coating or wax layers with thicknesses of 0.02 to 0.1 mm or ceramic layers of 0.0005 to 0.02 mm (e.g., a SiOx layer). On top of applied fiber materials, further fiber materials can be applied to the molded receptacles and/or covers as a further layer; these materials are highly ground, have a thickness of 0.1 mm to 0.3 mm, and have at least some of such properties. In a further embodiment, the functional layer which has a barrier effect is therefore a wax layer, a coating layer, or a ceramic layer, preferably an SiOx layer or a glass-ceramic material.

The portioning containers, or the receptacles and covers thereof, can have any shape, also referred to here as a contour, as long as this shape (or contour) can be produced using the molded fiber system and/or using the method according to the invention or as long as the molded fiber system and/or the method is suitable for manufacturing this shape (or contour). The components used for the molded fiber process can be adapted to the particular shape (or contour) of the portioning container, the receptacle, and the cover. In the case of different portioning containers, receptacles, and covers with different shapes (or contours), different correspondingly adapted components such as the suction tool, the suction head, the pre-pressing station, the hot-pressing station, etc., can be used.

The portioning container according to the invention therefore constitutes a biodegradable product made from natural fibers, which can be reproducibly manufactured effectively, flexibly, and with a high level of quality.

In one embodiment, the barrier layer system is made of biocompatible materials. Biocompatible materials are any material that does not have a negative impact on living beings in their environment. Such materials do not pose a health risk to users in portioning containers for consumables. Biocompatible materials include, for example, SiOx or titanium alloys.

In a further embodiment, the barrier layer system is applied to an inner surface of the receptacle, preferably also to an inner surface of the cover. The inner surfaces are the surfaces that face the sealed volume within the portion container. Since the consumable is in contact with the inner surfaces without a barrier layer, such layers applied there protect the consumable from any substances that could get into the sealed volume from the fiber material or through the fiber material. Such layers applied there likewise prevent substances from the consumable that would preferably be kept in the consumable for the relevant application, such as aromatic substances, from penetrating the fiber material.

In a further embodiment, the barrier layer system comprises a wax layer, a coating layer, a layer of PTFE, or a ceramic layer, preferably a SiOx layer or a glass-ceramic material. The portioning container can be sprayed with wax and/or a coating or be coated with PTFE or ceramic layers. The term “wax” refers to an organic compound that melts above approximately 40° C. and then forms a low-viscosity liquid. As a result, it is easy to apply waxes to a surface by spraying. Their low melting temperature makes it possible to saturate or impregnate fiber materials with wax. The process of the wax penetrating the fiber material can be supported by elevated temperatures above the melting point. Waxes are almost insoluble in water but soluble in organic, non-polar media. Waxes can be very different in terms of their chemical composition and origin and can in this case be waxes according to the definition of the German Society for Fat Science. Waxes that can be used here may include natural waxes such as animal waxes (e.g., wool wax, Chinese wax, beeswax, tallow, and insect wax) or vegetable waxes (e.g., sugar cane wax, carnauba wax, candelilla wax, cork wax, guaruma wax, ouricury wax, palm wax, esparto wax, cotton wax, rice bran wax, flax wax, peat wax, rose wax, jasmine wax, Peethe wax, bayberry wax, and waxy fig wax) and semi-synthetic or synthetic waxes (e.g., soy wax, rapeseed wax, and castor wax). The wax is preferably a wax approved as a food additive. The term “coating” refers to liquid or powdered coating materials. The coating or coating layer can be applied thinly to objects and is built up into a continuous, solid film (layer) by chemical or physical processes (e.g., evaporation of the solvent). Coatings usually consist of binding agents such as resins, dispersions or emulsions, fillers, pigments, solvents, and additives. The coating is preferably a coating approved for foodstuffs. The term “PTFE” refers to polytetrafluoroethylene, which is a fully fluorinated polymer. The PTFE coating is usually applied and then subjected to a temperature treatment. A PTFE coating is used as a non-stick coating in many applications. PTFE is very inert. Even aggressive acids cannot attack this coating. The reason for this is the particularly strong bond between the carbon and fluorine atoms. Many substances do not succeed in breaking the bonds and reacting with PTFE. Because of its chemical inertness, PTFE is used as a coating for, among other things, protecting the coated underlayers. The diverse and relatively simple compounding options allow special mixtures to be created for various applications.

In a further embodiment, the barrier layer system is also applied to an outer surface of the receptacle and/or the cover. Among other things, this can prevent substances from getting into the fiber material from the outside, which is undesirable for the application in question. This could be moisture, for example, which reduces the durability of the fiber material in the portioning container.

In a further embodiment, the barrier layer system applied to the outside consists of a material that can be printed on. In this way, useful information can be durably displayed on the portioning containers.

In a further embodiment, the receptacle made of biodegradable fiber material is formed from a first molded part made of a first fiber material from a first pulp and a second molded part made of a fiber material from a second or further pulp that is different from the first pulp, the first and second molded parts being interconnected by means of a pre-compression pressure in the pre-forming station via their respective mutually facing surfaces. In this way, receptacles can be provided with functional layers, for example barrier layers, without having to use a separate additional coating technique in the molded fiber process. The adhesion of the two parts to fiber material is brought about by the molded fiber process itself so that no additional adhesion promoters have to be applied between these parts made of fiber material, which simplifies the molded fiber process. The outer molded part can be manufactured, for example, from a material that can be printed on or from a material that is resistant to environmental influences, while the inner molded part can be adapted to the needs of the particular consumable.

In a further embodiment, the biodegradable fiber material of the portion receptacle has a liquid solution content of less than 10%, preferably less than 7%, in the molded fiber process after the final shaping of the receptacle. This liquid solution content makes the receptacle dimensionally stable for the subsequent processes.

In a further embodiment, the biodegradable fiber material of the portion container is correspondingly compacted by a double-pressing process consisting of pre-pressing in a pre-forming station and hot-pressing in a hot-pressing station at a temperature higher than during pre-pressing.

In a further embodiment, the biodegradable fiber material contains no organic binder, preferably likewise no non-organic binder. Without binders, the portioning containers manufactured from originally biodegradable fiber material can continue to degrade in an environmentally friendly manner, since no environmentally harmful binder, preferably no binder at all, is used. The omission of binders is made possible by the combination of the integral molding, pre-pressing, and hot-pressing steps, which in their entirety ensure good mechanical interlinking of the individual fibers with one another in the fiber material of the portioning container. The mechanical linkage is so strong in this case that binders can be omitted to ensure the dimensional stability of the molded part.

In a further embodiment, the biodegradable fiber material substantially consists of fibers with a fiber length of less than 5 mm. In the case of fibers of this length, a good, homogeneous solution of the fiber material in the liquid solution is obtained, among other things, so that the degree of clumping of the fibers in the pulp is sufficiently low for a good, reproducible molded fiber process for the portioning container or the receptacle and the cover. In addition, shorter fibers reduce the surface roughness and porosity of the fiber material, making it easier to apply potential coatings to the fiber material.

In a further embodiment, a wall thickness of the receptacle, preferably also of the cover, varies over all surfaces of the receptacle by less than 7% with respect to a target thickness. The portioning containers are therefore well suited as portioning containers for subsequent processing machines for releasing the consumable, for example coffee machines for coffee pads.

In another embodiment, the receptacle is shaped in such a way that all surfaces of the receptacle have an angle of at least 3 degrees with respect to an axis of symmetry which is oriented perpendicularly to a bottom surface of the receptacle. This ensures that the hot-press pressure can be applied to all surfaces of the receptacle or cover. No pressure can be applied to surfaces parallel to the direction of pressure during hot-pressing. The hot-press pressure is applied hydraulically to the hot-pressing station, for example via a press unit, preferably a piston rod, said press unit pressing, for example, on the hot-press upper die, which then in turn presses on the stationary hot-press lower die, with the receptacle or cover therebetween. This arrangement could also be inverted.

In a further embodiment, the receptacle is integrally formed from a wall surface and the bottom surface. This facilitates the manufacture and tightness of the receptacle.

In a further embodiment, the portioning container or its components can be stacked. This simplifies the logistical processes involved in storage, transport, and provision for the customer, since stacked products require less space than non-stackable products. The components in this case are the receptacle and the cover.

In a further embodiment, the receptacle comprises, at its end opposite the bottom surface, a circumferential flat receptacle edge. The circumferential edge can be used to secure the cover and/or for stackability.

In a further embodiment, the receptacle has a stacking edge. This stacking edge allows the receptacles to be stacked in a defined manner. The stacking edge can be designed to have different shapes at different positions of the receptacle. For example, the stacking edge can be part of the circumferential receptacle edge.

In a further embodiment, the portioning container is consumable. In the case of consumable fiber materials, the portioning container can biodegrade without leaving any residue.

In a further embodiment, the portioning container can hold at least one second consumable. This increases the variety of possibilities in terms of taste, processing, and use of the portioning container.

In a further embodiment, the sealed volume is divided into at least two separate volumes. As a result, the two consumables are not mixed until the portioning container is used by the user. In a further embodiment, the receptacle has a partition between the separate volumes for this purpose.

In a further embodiment, the cover comprises at least one outlet for the consumable in the volume. As a result, the consumable can be poured out or drunk from the portioning container, for example. Preferably each volume has one of the outlets individually.

In another embodiment, the cover divides an incoming liquid flow into the volume into at least two liquid flows in respective separate volumes. In this way, the portioning container can be used twice in succession. In a brewing process, for example, it is possible to choose whether the brewing process is to be stronger or weaker. In a further embodiment, the bottom surface also has at least two separate taps for this purpose.

In another embodiment, the cover has a resealable tap. As a result, a consumable that has not yet been fully consumed in the portioning container can be protected from external influences, such as cooling, changes in aroma, etc.

In a further embodiment, the receptacle has, on its bottom surface, a base ring at the transition between the bottom surface and the wall surface so that it can be placed stably on a base, for example.

In a further embodiment, the receptacle has a transition from the bottom surface to the wall surface, which transition is rounded or has one or more discrete contours, preferably ribs or beads. This promotes, among other things, the stability of the receptacle.

In a further embodiment, the receptacle has one or more discrete contours, preferably ribs or beads, within the wall surface. This likewise promotes, among other things, the stability of the receptacle.

In a further embodiment, the receptacle has a wall surface with different thicknesses. The receptacle can thus be reinforced locally and material can be saved in other places where this reinforcement is not necessary.

In a further embodiment, the bottom surface is designed as a hollow base. This likewise promotes, among other things, the stability of the receptacle.

In a further embodiment, the bottom surface is roughened or has corrugations. This increases the slip resistance of the portioning container on a base.

In a further embodiment, at least the receptacle, preferably the entire portioning container, is spherical in shape. This makes it easier to provide the portioning container in a corresponding dispenser stand, for example.

The above embodiments, in particular the stackability of the portioning container, the stacking edge required therefor, the circumferential receptacle edge, the option of holding a second consumable, the possible design with two separate volumes, the partition, the possibility of dividing into the separate volumes into two liquid flows, the separate taps, the resealable tap, the base ring, the discrete contours, the hollow base, the corrugations, and the spherical shape, are made possible in particular by the molded fiber process according to the invention being able to provide a dimensionally stable portioning container. This is also achieved, for example, by increasing the dimensional stability to the required level by sufficiently reducing the liquid solution content in the fiber material of the portioning container after final shaping, for example to less than 10%, preferably less than 7%.

In a further embodiment, the portioning container encompasses the consumable and the cover closes the receptacle. This keeps the consumable fresh and usable for longer.

In a further embodiment, the portioning container is a hot-beverage capsule, preferably a coffee capsule.

The invention further relates to a molded fiber system for manufacturing portioning containers according to one of the preceding claims, comprising
a reservoir for providing a pulp as a liquid solution containing biodegradable fiber material;
a molding station having a suction tool with a large number of suction heads adapted to the contour of the receptacle and/or cover of the portioning container to be manufactured, in order to integrally mold the receptacles and/or covers by sucking the pulp into the respective suction heads;
a pre-forming station for pre-pressing the molded receptacles and/or cover of the portioning container;
a hot-pressing station for producing the final shape of the pre-formed receptacles and/or covers of the portioning containers;
a coating station for applying a barrier layer system to the integrally molded, pre-formed or final-shaped receptacles and/or covers of the portioning containers; and
a dispensing station for dispensing the final-shaped receptacles and/or covers or the portioning containers from the molded fiber system.

The pulp can be provided at a temperature of less than or equal to 80° C., preferably less than or equal to 50° C., particularly preferably at room temperature. These low temperatures allow, among other things, simple process control, in particular at room temperature.

The suction tool refers here to the tool in which the suction head/s is/are arranged for molding the molded part. In the case of a single suction head, this is also the suction tool. If there are a plurality of suction heads that are operated simultaneously, they are all arranged in the common suction tool (multi-tool) so that, when the suction tool is moved, the individual suction heads in the suction tool are moved with it in the same way. The supply of media to the suction tool with a plurality of suction heads is routed in a suitable manner to the individual suction heads in the suction tool.

For integral molding, the suction tool is at least partially immersed in the pulp in order to suck out the fiber material from the pulp using a vacuum applied to the pulp via the suction tool or to suck in the pulp together with the fiber material dissolved therein. The immersion depth of the suction tool in the pulp depends on the particular application and the particular molded fiber process and can differ depending on the application and possibly on the portioning container to be molded. In one embodiment, the suction side of the suction head is formed of a porous screen, on the pulp side of which (the side facing the pulp) the biodegradable fiber adheres due to the suction in order to integrally mold the receptacle or the cover of the portioning container. The screen must have a porosity so that the pulp together with the fiber material can be sucked through the screen and the liquid solution of the pulp can pass through the screen. However, the porosity of the screen must not be too great so that the fiber material can adhere to the pulp side.

In this regard, the suction head can have what is known as a negative mold. A negative mold is a mold where the suction side of the suction head, i.e., the side where the fiber material is deposited due to the suction effect of the suction head and thus forms the receptacle or the cover, is on the inside of the suction head so that this inner side forms a cavity after the suction head has been placed on the pulp or the suction head has been immersed in the pulp, into which cavity the pulp containing the fiber material is sucked (as shown in FIG. 2). In the case of a negative mold, the outer side of the subsequent receptacle or cover faces the inside of the suction head. The molded part (receptacle or cover) therefore sits on the inside of the suction head after molding. In the present invention, the molded part refers to the receptacle or the cover of the portioning container.

In this regard, the suction head can also alternatively have what is known as a positive mold. A positive mold is a mold where the suction side of the suction head, i.e., the side where the fiber material is deposited due to the suction effect of the suction head and thus forms the molded part, is on the outside of the suction head so that this outer side does not form a cavity after the suction head has been placed on the pulp or the suction head has been immersed in the pulp. In the case of a positive mold, the inside of the subsequent molded part faces the outsides of the suction head. After molding, the molded part therefore sits on the outside of the suction head.

The integral molding of the molded part in the molding station refers to a first shaping of the molded part, this part being formed from fiber material previously randomly distributed in the pulp by means of attachment of the fiber material to the contour of the suction head with the corresponding contour. The formed molded part still has a large proportion, for example 70%-80%, of liquid solution, for example water, and is therefore not yet dimensionally stable. The pre-pressing of the molded part in the pre-forming station significantly reduces the proportion of liquid solution in the molded part, for example to 55%-65%, so that the contour of the molded part is now significantly more stable. By hot-pressing the pre-pressed molded part in the hot-pressing station with a hot-press pressure, the molded part is given its final shape with a further reduction in the liquid solution proportion in the molded part, for example to below 10%, preferably to approximately 7%, after which it is then stable and dimensionally stable.

Dispensing the final-shaped molded part by means of the dispensing station refers to the delivery of the molded part for onward transport or for further processing, for example to cutting, labeling, printing, and/or packing stations.

The coating station for applying a barrier layer system can be located at any suitable position in the molded fiber process between the molding station and the dispensing station in order to apply said system to the molded, pre-formed, or final-formed receptacle and/or cover of the portioning container. In one embodiment, the coating station is configured to perform a physical layering process or vapor deposition, preferably evaporation deposition, plasma coating, or spraying.

By combining the molding, pre-pressing, and hot-pressing steps, it is possible to manufacture, in a simple manner from a fiber material, a molded part which can very flexibly deliver, depending on the design of the contour of the suction head, molded parts with a very wide variety of contours. The ratio of the width or diameter to the height of the molded part does not constitute a limiting or critical parameter for the quality of the manufacturing of the respective molded parts. By combining the molding, pre-pressing, and hot-pressing steps, the molded parts can be manufactured highly reproducibly and with great accuracy and quality with regard to the shape and layer thickness of the individual molded part portions. The molded fiber system is able to process fibers of all kinds, as long as they can be dissolved in such a way that the formation of large clumps of fibers in the liquid solution can be avoided before processing. In particular, in this way, stable molded parts can be manufactured easily, effectively, and flexibly from biodegradable fiber material with a high level of quality and reproducibility.

Using the molded fiber system according to the invention, portioning containers can be reproducibly manufactured from natural fibers effectively, flexibly, and with a high level of quality as a biodegradable product. In particular, the stations used—the molding station, the pre-forming station, and the hot-pressing station—individually or in combination with one another, allow the liquid solution content in the final-shaped portioning container to be so low that the portioning container is particularly dimensionally stable.

In a further embodiment, the pre-forming station comprises a pre-press lower die, to which the suction tool with the integrally molded part (receptacle or cover of the portioning container) is attached so that the molded part is arranged between the pre-press lower die and the suction tool and the suction tool is pressed onto the pre-press lower die by the pre-compression pressure. The suction tool is designed for exerting the pre-compression pressure on the pre-press lower die. The suction tool can be pressed onto a stationary pre-press lower die or the pre-press lower die is pressed onto a stationary suction tool. For this purpose, the suction tool can be attached to a robot arm, which itself exerts the pre-compression pressure on the pre-press lower die via the suction tool. Analogously to a suction tool as a multi-tool, the pre-press lower die can also be designed as a multi-tool in order to apply the pre-compression pressure to all molded parts (receptacle or cover of the portioning container) of the suction tool simultaneously and thus to perform the pre-pressing for all molded parts simultaneously.

In a further embodiment, the pre-pressing is performed in a pre-pressing station temperature of less than 80° C., preferably less than 50° C., particularly preferably at room temperature. Too high a temperature would lower the liquid content in the molded part too far, which could make the material too stiff for the subsequent hot-pressing. It is precisely the combination of pre-pressing and hot-pressing that enables the reproducible manufacture of good-quality molded parts with a low number of rejects. In a further embodiment, the pre-pressing is performed with the pre-compression pressure between 0.2 N/mm² and 0.3 N/mm², preferably between 0.23 N/mm² and 0.27 N/mm². These moderate pressures, which are lower than the hot-press pressure, enable gentle solidification of the molded part with a moderate reduction in liquid, which is advantageous for a low-reject hot-pressing process.

In a further embodiment, the hot-pressing station comprises a hot-press lower die with a hot-press side adapted to a contour of the molded part and a correspondingly shaped hot-press upper die, wherein, during transfer, the molded part is placed or inserted from the suction tool onto the hot-press lower die and, during hot-pressing, the hot-press upper die is pressed onto the hot-press lower die with the molded part arranged therebetween. Depending on whether the suction heads of the suction tool have a negative or positive mold, the molded part is placed on the hot-press lower die (negative mold) or inserted (positive mold). In this respect, the hot-press side is the outer side in the case of a negative mold and the inner side of the hot-press lower die in the case of a positive mold. In each case, the hot-press upper die has a correspondingly complementary shape. The two hot-press upper and lower dies can work together to apply high pressures at high temperatures to the molded part located therebetween. In a further embodiment, at least the hot-press lower die is made of metal for this purpose. In a further embodiment, the hot-pressing is performed at a temperature of greater than 150° C., preferably between 180° C. and 250° C. This allows the liquid (or moisture) in the molded part to be reduced to less than 10%. In a further embodiment, the hot-pressing is performed with the hot-press pressure higher than the pre-compression pressure. This allows the liquid (or moisture) in the molded part to be reduced to less than 10%, in particular in combination with the above temperatures. In a further embodiment, the hot-press pressure is performed between 0.5 N/mm² and 1.5 N/mm², preferably between 0.8 N/mm² and 1.2 N/mm². In a further embodiment, the hot-press pressure is applied for a pressing time of less than 20 s, preferably more than 8 s, particularly preferably between 10 and 14 s, even more preferably 12 s. This allows the liquid (or moisture) in the molded part to be reduced to less than 10%, in particular in combination with the above temperatures and hot-press pressures.

In one embodiment, the molded fiber system comprises a control unit for controlling the method that is carried out. The control unit can be designed as a processor, a separate computer system, or as web-based and is suitably connected to the components of the molded fiber system to be controlled, for example via data cable or wirelessly by means of WLAN, radio, or other wireless transmission means.

In a further embodiment, the molded fiber system comprises one or more assembly stations for filling the receptacles with consumables and/or for closing the receptacles with the respective covers. For this purpose, the assembly station for filling the receptacle can be equipped with suitable pouring means or other portioning means. The assembly station for closing the receptacle can be designed to glue, clamp, press, or screw the cover onto the receptacle.

The invention also relates to a method for manufacturing portioning containers according to the invention using a molded fiber system according to the invention, comprising the following steps:
providing a reservoir of pulp as a liquid solution containing biodegradable fiber material;
integrally molding receptacles and/or covers of the portioning containers to be manufactured in a molding station having a suction tool with a large number of suction heads adapted to the contour of the receptacle and/or cover by sucking the pulp into the respective suction heads;
pre-pressing the integrally molded receptacles and/or covers of the portioning containers in a pre-forming station;
producing the final shape of the pre-formed receptacles and/or covers of the portioning containers in a hot-pressing station;
applying a barrier layer system to the integrally molded, pre-formed, or final-shaped receptacles and/or covers of the portioning containers in a coating station; and
dispensing the final-shaped receptacles and/or covers or the portioning containers from the molded fiber system by means of a dispensing unit.

Using the molded fiber system according to the invention, portioning containers can be reproducibly manufactured from natural fibers effectively, flexibly, and with a high level of quality as a biodegradable product. In particular, the steps of integrally molding, pre-pressing, and producing the final shape by means of a hot-pressing station (hot-pressing), individually or in combination with one another, allow the liquid solution proportion in the final-shaped portioning container to be so low that the portioning container is particularly dimensionally stable.

In one embodiment of the method, the method includes one of the further steps of:
filling the receptacles with consumables in an assembly station; and/or
closing the receptacles with the respective covers in another assembly station.

Express reference is made to the fact that, for the purpose of better readability, “at least” expressions have been avoided as far as possible. Rather, an indefinite article (“one”, “two”, etc.) is normally to be understood to mean “at least one”, “at least two”, etc., unless it follows from the context that “exactly” the specified number is meant.

At this point, it should also be mentioned that within the scope of the present patent application the expression “in particular” is always to be understood to mean that an optional, preferred feature is being introduced with this expression. The expression is therefore not to be understood as “specifically”, nor as “namely”.

It goes without saying that features of the solutions described above or in the claims can also optionally be combined in order to be able to cumulatively implement the advantages and effects that can be achieved herein.

### BRIEF DESCRIPTION OF THE FIGURES

In addition, further features, effects, and advantages of the present invention are explained with reference to the attached drawings and the following description. Components which correspond at least substantially in terms of their function in the individual figures are identified by the same reference symbols, it not being necessary for the components to be numbered and explained in all the figures.

In the drawings:

FIG. 1: is a schematic representation of a portioning container according to the invention;

FIG. 2: shows different embodiments of the receptacle and the cover with a barrier layer system on the (a) outside, (b) inside, and (c) on both sides of the receptacles and covers;

FIG. 3: shows an embodiment of the receptacle formed from first and second molded parts made of fiber material;

FIG. 4: shows an embodiment of the portioning container with two separate volumes filled with respective consumables;

FIG. 5: shows an embodiment of the molded fiber system according to the invention;

FIG. 6: shows another embodiment of the molded fiber system according to the invention having two pulp reservoirs containing different pulps for manufacturing receptacles and/or covers from first and second molded parts; and

FIG. 7: shows an embodiment of the method according to the invention.

### EXEMPLARY EMBODIMENTS

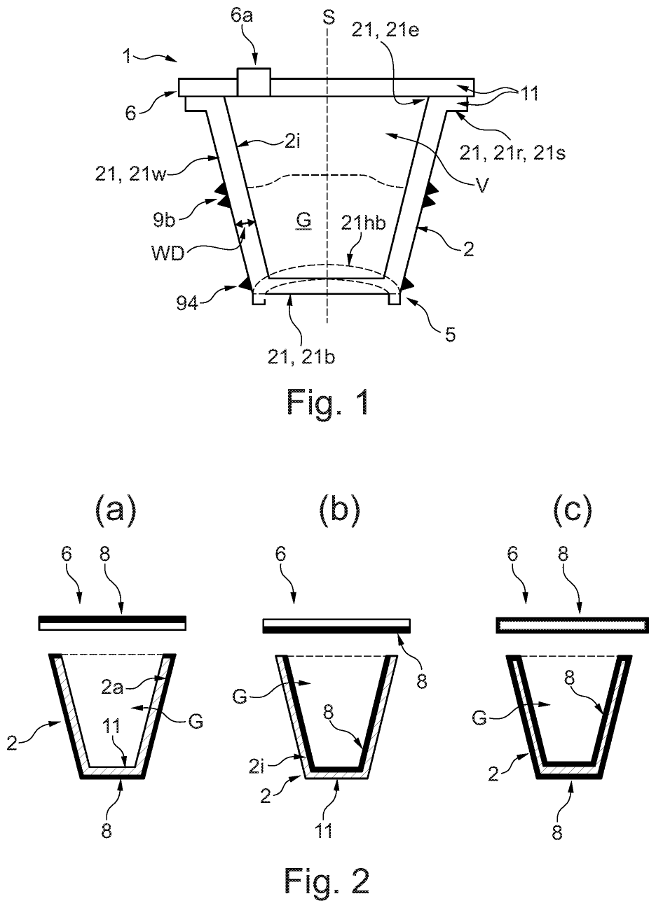

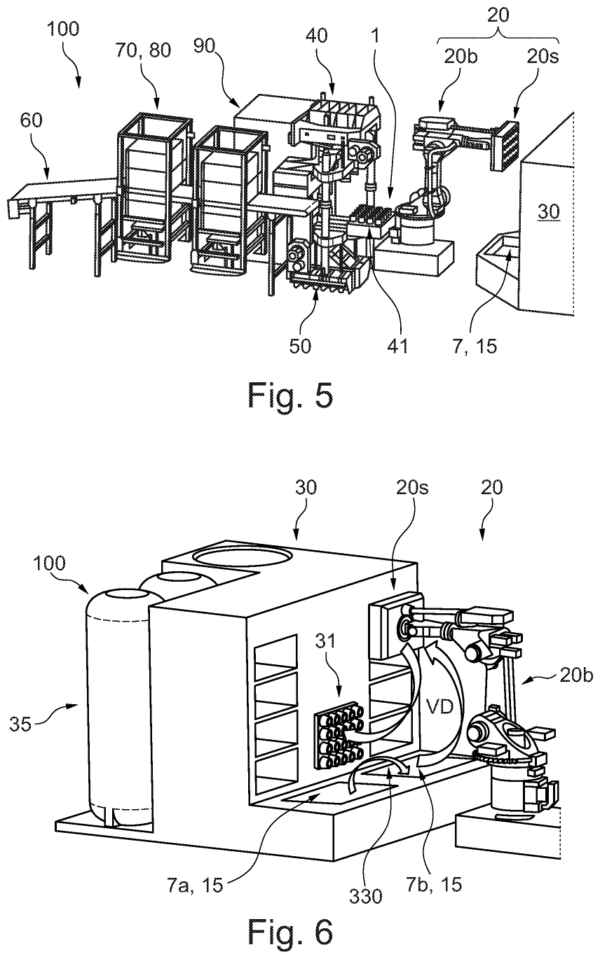

FIG. 1 is a schematic representation of a portioning container 1 according to the invention, comprising a receptacle 2 for holding a consumable G, G′ and a cover 6 for closing the receptacle to produce a sealed volume V within the portioning container 1, wherein the receptacle 2 and the cover 6 are produced from biodegradable fiber material 11, for example produced from a pulp 7, 7a, 7b as a liquid solution containing the biodegradable fiber material 11 using a molded fiber system 100 (see FIGS. 5 and 6) by means of a molded fiber process, wherein at least the receptacle 2, preferably also the cover 6, is provided with a barrier layer system 8 which has a barrier effect at least against penetration of moisture, water, aromatic substances, flavoring agents, odorants, and/or non-food-grade substances (see, inter alia, FIG. 2). The biodegradable fiber material 11 of the portion receptacle 1 has a liquid solution proportion of less than 10%, preferably less than 7%, in the molded fiber process after the final shaping of the receptacle 2. The biodegradable fiber material 11 of the portion container 1 is correspondingly compacted by a double-pressing process consisting of pre-pressing in a pre-forming station 20 and hot-pressing in a hot-pressing station 30 at a temperature higher than during pre-pressing. The biodegradable fiber material 11 preferably contains no organic binder, preferably likewise no non-organic binder, and consists substantially of fibers with a fiber length of less than 5 mm. In the portioning container shown, a wall thickness WD of the receptacle 2, preferably also of the cover 6, varies over all surfaces of the receptacle 2 by less than 7% with respect to a target thickness. In this regard, the receptacle 2 is shaped in such a way that all surfaces 21 of the receptacle 2 have an angle of at least 3 degrees with respect to an axis of symmetry S which is oriented perpendicularly to a bottom surface 21b of the receptacle 2. The same applies to the cover 6. The thickness of the cover 6 in the direction of symmetry S is not regarded as a surface. The receptacle 2 is integrally formed from a wall surface 21w and the bottom surface 21b, which makes it easier to assemble the portioning container. The portioning container 1 or its components 2, 6 can additionally be stacked. For this purpose, the receptacle 2 comprises, at its end 21e opposite the bottom surface 21b, a circumferential flat receptacle edge 21r, which functions as a stacking edge 21s. Furthermore, the portioning container 1 can be manufactured from a consumable fiber material. The cover 6 in this case comprises an outlet 6a for the consumable in the volume V, as a result of which the portioning container can serve as a cup. For better stability, the receptacle 2 has, on its bottom surface 21b, a base ring 5 at the transition between the bottom surface 21b and the wall surface 21w. Furthermore, the receptacle 2 has a transition from the bottom surface 21b to the wall surface 21w, which transition is rounded or has one or more discrete contours 9a, preferably ribs or beads. In addition, the receptacle 2 has one or more discrete contours 9b, preferably ribs or beads, within the wall surface 21w. These measures make the receptacle 2 mechanically more robust. The receptacle 2 has a wall surface 21w with different thicknesses. The bottom surface 21b can also be designed as a hollow base 21hb (shown in dashed lines). Furthermore, the bottom surface 21b can be roughened with or without a base ring or have corrugations. In an embodiment not shown here, the receptacle 2, preferably the entire portioning container 1, can also be spherical in shape. The finished portioning container 1 encompasses the consumable G, with the cover 6 closing the receptacle 2. In one embodiment, the portioning container 1 is a hot-beverage capsule, preferably a coffee capsule.

FIG. 2 shows different embodiments of the receptacle 2 and the cover 6 with barrier layer systems 8 on the (a) outside, (b) inside, and (c) on both sides of the receptacles 2 and covers 6. In this case, the receptacle 2 and the cover 6 are each provided with a barrier layer system 8 which has a barrier effect at least against penetration of moisture, water, aromatic substances, flavoring agents, odorants, and/or non-food-grade substances. The barrier layer system 8 can be made of biocompatible materials. In FIG. 2a, the barrier layer system 8 is applied to both the outer surface 2a of the receptacle 2 and the cover 6, which prevents substances from penetrating the fiber material 11 from the outside or escaping from the fiber material 11 to the outside. However, substances can get from the fiber material 11 into the consumable G or, vice versa, from the consumable G into the fiber material 11. This type of coating is particularly expedient if the fiber material 11 has to be protected against external influences, for example water, so that the fiber material 11 does not unintentionally dissolve. In FIG. 2b, the barrier layer system 8 is applied to both the inner surface 2i of the receptacle 2 and the cover 6, which protects the consumable G against all substances from the environment and the fiber material 11 and prevents the release of substances from the consumable G. This type of coating in particular protects the consumable G from external impairments and, for example, from a loss of aroma to the outside. In FIG. 2c, the barrier layer system 8 is applied to both sides of the receptacle 2 and the cover 6, which combines the advantages of the two previous variants but requires greater effort in terms of coating. The barrier layer system 8 can comprise a wax layer, a coating layer, a layer of PTFE, or a ceramic layer, preferably a SiOx layer or a glass-ceramic material. The barrier layer system 8 applied to the outside can consist of a material that can be printed on.

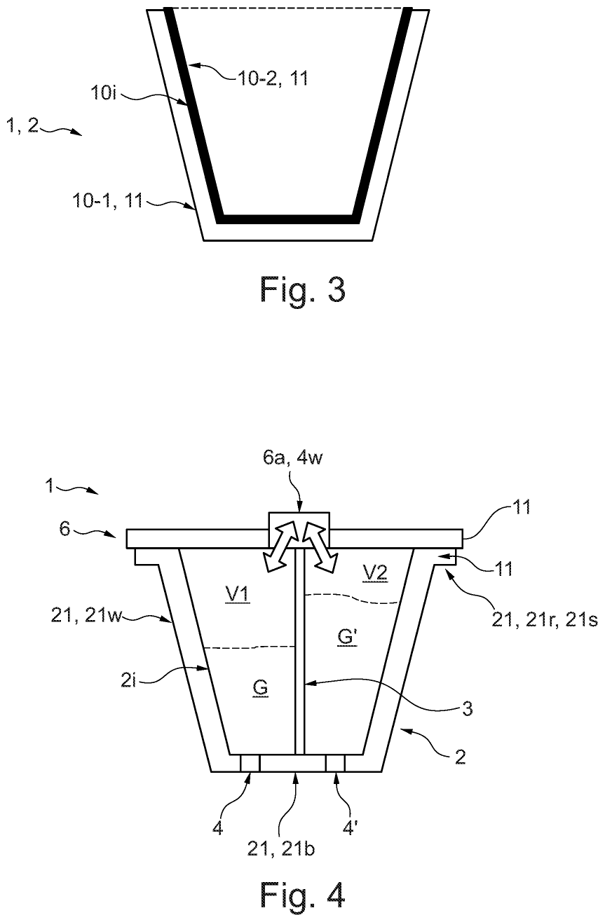

FIG. 3 shows an embodiment of the receptacle 2 made of first and second molded parts 10-1, 10-2 made of fiber material 11. In this case, the receptacle 2 made of biodegradable fiber material 11 is formed from a first molded part 10-1 made of a first fiber material 11 from a first pulp 7a, as the outer part of the receptacle 2, and from a second molded part 10-2 made of a fiber material 11 from a second or further pulp 7b that is different from the first pulp 7a, as the inner part of the receptacle 2. The first and second molded parts 10-1, 10-2 are firmly interconnected at an interface 10i by means of a pre-compression pressure VD in the pre-forming station 20 via their respective mutually facing surfaces. What is stated above for the receptacle 2 of the portioning container 1 applies equally to the cover 6, which can likewise be manufactured from a first molded part 10-1 and a second molded part 10-2.

FIG. 4 shows an embodiment of the portioning container 1 having two separate volumes V1, V2 filled with respective consumables G, G′, so that the portioning container 1 can hold at least one second consumable G′. For this purpose, the sealed volume V shown in FIG. 1 is divided here into two separate volumes V1, V2 by virtue of the receptacle 2 having a partition 3 between the separate volumes V1, V2. The cover 6 here comprises an outlet 6a for the consumables in the volumes V1, V2; the outlet takes the form of an individual outlet for each volume V1, V2. This outlet 6a can be used, for example, as a drinking cup for portioning containers 1 (arrows pointing upward). Alternatively, the cover 6 can divide an incoming liquid flow into the volume V into at least two liquid flows in respective separate volumes V1, V2 (arrows pointing downward). For this purpose, the cover 6 can have a resealable tap 4w, which is shown here as the same part as the outlet 6a for the sake of clarity. In the alternative embodiment, the bottom surface 21b can have two separate taps 4, 4′, one for each of the separate volumes V1, V2. In this embodiment, the portioning container 1 can be used, for example, as a coffee capsule for two different types of coffee or for a coffee with additives, wherein one of the volumes V1 is filled with the coffee powder to be brewed, for example, as one consumable G, and the other volume V2 is filled with milk powder, for example, as the other consumable G′ for a white coffee. After brewing, the two consumables G, G′ can be dispensed for consumption via the two taps 4, 4′ into a vessel. The hot water for brewing reaches the two volumes V1, V2 via the tap 4w in the cover 6, with the tap 4w being designed to divide the water flow into separate water flows for the respective volumes V1, V2 (see arrows), with the strength of the respective divided water flows being preset by the design of the tap 4w.

FIG. 5 shows an embodiment of the molded fiber system 100 according to the invention for manufacturing portioning containers 1 according to the invention, comprising a reservoir 15 for providing a pulp 7 as a liquid solution containing biodegradable fiber material 11; a molding station 20 having a suction tool 20s with a large number of suction heads adapted to the contour of the receptacle 2 and/or cover 6 of the portioning container 1 to be manufactured, in order to integrally mold the receptacle 2 and/or covers 6 by sucking the pulp 7 into the respective suction heads, wherein the suction tool 20s is mounted on a moving unit 20b, for example a robot with a robot arm; a pre-forming station 30 for pre-pressing the molded receptacles 2 and/or cover 6 of the portioning container 1 comprising the pulp reservoir 15; a hot-pressing station 40 for producing the final shape of the pre-formed receptacles 2 and/or covers 6 of the portioning containers 1, wherein the portioning containers or the receptacles 2 and/or the covers 6 are transferred to a pre-press lower die 41 by means of the suction tool 20s and are hot-pressed in the hot-pressing station 40 between the hot-press lower die 41 and a correspondingly shaped hot-press upper die (not shown here in detail); a coating station 50 for applying a barrier layer system 8 to the integrally molded, pre-formed, or final-shaped receptacles 2 and/or covers 6 of the portioning containers 1; and a dispensing station 60 for dispensing the final-shaped receptacles 2 and/or covers 6 or the portioning containers 1 from the molded fiber system 100. The molded fiber system 100 in this case also comprises one or more assembly stations 70, 80 for filling the receptacles 2 with consumables G, G′ and/or for closing the receptacles 2 with the respective covers 6.

FIG. 6 shows another embodiment of the molded fiber system 100 according to the invention having two pulp reservoirs 15 containing different pulps 7a, 7b for producing receptacles 2 from first and second molded parts 10-1, 10-2. In this case, the first, second, and optionally further pulps 7a, 7b differ in terms of their compositions, their solvents, their fiber materials, their concentrations, and/or in proportions and/or in terms of their type of dopant, if any. The molded fiber system 100 here comprises a second reservoir 15 containing a second pulp 7b, in order to, via a partial second immersion 300 of the suction tool 20s with or without molded parts 10-1 already molded from the first pulp 7a in the suction heads, fill said parts with a second fiber layer as a second molded part 10-2. So that the two pulp reservoirs 15 are supplied with pulp 7a, 7b for the ongoing production process, the pre-forming station 20 comprises a pulp processing and subsequent delivery station 35. In addition, the pre-press lower die 31 is arranged as a multi-tool on the pre-forming station 30 in such a way that the solution or pulp pressed out during pre-forming can be collected and fed back directly to the two pulp reservoirs 15. In this case, the suction tool 20s is arranged on a robot arm of the moving unit 20b, since the robot arm can reliably approach the two pulp reservoirs 15 with the suction tool 20s. For this purpose, the robot arm first immerses the suction tool 20s, for example, into the first pulp reservoir 15 containing the first pulp 7a so that the first molded part 10-1 is integrally molded from the first pulp 7a. The suction tool 20s is then immersed a second time into the second pulp reservoir 15 containing the second pulp 7b so that further fiber material 11 from the second pulp 7b is molded onto the previously molded first molded part 10-1 as a second molded part 10-2 as a result of the suction process.

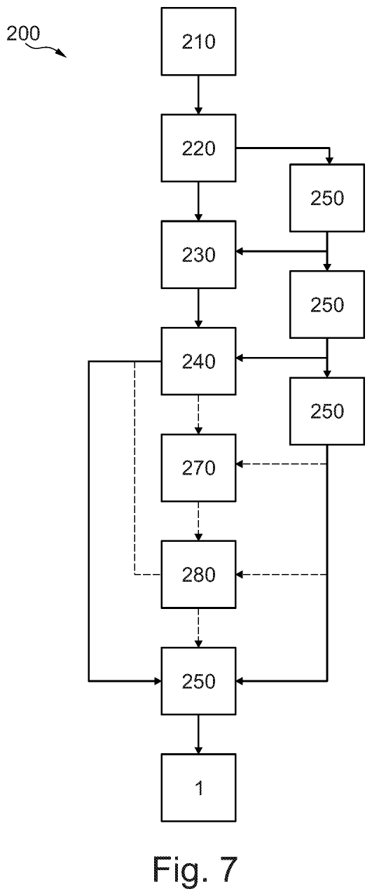

FIG. 7 shows an embodiment of the method 200 according to the invention for producing portioning containers 1 according to the invention using a molded fiber system 100 according to the invention, comprising the steps of providing 210 a reservoir 10 of pulp 7 as a liquid solution containing biodegradable fiber material 11; integrally molding 220 receptacles 2 and/or covers 6 of the portioning containers 1 to be manufactured in a molding station 20 having a suction tool with a large number of suction heads adapted to the contour of the receptacle 2 and/or cover 6 by sucking the pulp 7 into the respective suction heads; pre-pressing 230 the integrally molded receptacles 2 and/or covers 6 of the portioning containers 1 in a pre-forming station 30; producing the final shape 240 of the pre-formed receptacles 2 and/or covers 6 of the portioning containers 1 in a hot-pressing station 40; applying 250 a barrier layer system 8 to the integrally molded, pre-formed, or final-shaped receptacles 2 and/or covers 6 of the portioning containers 1 in a coating station 50; and dispensing 260 the final-shaped receptacles 2 and/or covers 6 or the portioning containers 1 from the molded fiber system 100 by means of a dispensing unit 60. The different points in time at which the barrier layer system 8 can be applied is represented by a number of application steps 250. In this case, the components are not necessarily coated several times but can be coated at any point 250 shown. The method can also (shown in dashed lines) comprise the step of filling 270 the receptacles 2 with consumables G, G′ in an assembly station 70 and/or closing 280 the receptacles 2 with the respective covers 6 in another assembly station 80.

At this point, it should be explicitly pointed out that features of the solutions described above or in the claims and/or drawings can also be combined, if necessary, in order to be able to cumulatively implement or achieve explained features, effects, and advantages.

It goes without saying that the exemplary embodiment explained above is merely a first embodiment of the present invention. In this respect, the embodiment of the invention is not limited to this exemplary embodiment.

### LIST OF REFERENCE SIGNS

1 portioning container
2 receptacle
2i inner surface of the receptacle
2a outer surface of the receptacle
21 surface of the receptacle
21b bottom surface of the receptacle
21hb bottom surface as hollow base
21e end of receptacle opposite the bottom surface
21r circumferential edge of the receptacle
21s stacking edge of the receptacle
21w wall surface of the receptacle
3 partition
4, 4′ taps of the bottom surface
4w resealable tap
5 base ring
6 cover
6a outlet for the consumable
7 pulp
7a first pulp
7b second pulp
8 barrier layer system
9a discrete contour, for example rib or bead, at the transition from the bottom surface to the wall surface
9b discrete contour, for example rib or bead, within the wall surface
10-1 first molded part of the receptacle (or cover)
10-2 second molded part of the receptacle (or cover)
10i interface between the first and second molded part
11 fiber material
15 reservoir of pulp
20 molding station
20s suction tool
20b moving unit
30 pre-forming station
31 pre-press lower die
35 pulp preparation and subsequent delivery unit
40 hot-pressing station
41 hot-press lower die
50 coating station
60 dispensing station
70 assembly station for filling the receptacle with consumables
80 assembly station for closing the receptacle with the cover to complete the portioning container
90 control unit
100 molded fiber system
200 method for producing portioning containers
210 providing a reservoir of pulp
220 integrally molding receptacles and/or covers of the portioning containers to be manufactured
230 pre-pressing the integrally molded receptacles and/or cover of the portioning container
240 producing the final shape of the pre-formed receptacles and/or cover of the portioning container
250 applying a barrier layer system to the integrally molded, pre-formed, or
260 final-shaped receptacles and/or cover of the portioning containers dispensing the final-shaped receptacles and/or cover or the portioning containers from the molded fiber system
270 filling the receptacles with consumables
280 closing the receptacles with the respective covers
G, G′ consumables
S axis of symmetry
V sealed volume
V1, V2 separate volumes
VD pre-compression pressure
WD wall thickness

1-38. (canceled)

39. A portioning container, comprising:
a receptacle for holding a consumable, wherein the receptacle is manufactured from a biodegradable fiber material, wherein the receptacle is formed from a first molded part made of a first fiber material and a second molded part made from a second, different fiber material, wherein the first and second molded parts are interconnected via their respective mutually facing surfaces by pre-compression pressure applied during a pre-forming process; and
a cover for closing the receptacle to produce a sealed volume within the portioning container.

40. The portioning container of claim 39, wherein the receptacle includes a partition that divides the sealed volume into at least a first volume and a second volume.

41. The portioning container of claim 40, wherein the cover includes a plurality of outlets such that both the first volume and the second volume are associated with one or more of the plurality of outlets.

42. The portioning container of claim 39, wherein the portioning container further comprises:
a barrier layer applied to at least one surface of the receptacle or the cover, wherein the barrier layer prevents penetration of one or more of: moisture, water, aromatic substances, flavoring agents, odorants, or non-food-grade substances.

43. The portioning container of claim 42, wherein the barrier layer includes one or more of: a wax layer, a coating layer, a layer of polytetrafluoroethylene (“PTFE”), or a ceramic layer.

44. The portioning container of claim 42, wherein the barrier layer is a ceramic layer having a thickness of between 0.0005 mm and 0.02 mm.

45. The portioning container of claim 42, wherein the barrier layer is applied to an inner surface of the receptacle and an inner surface of the cover.

46. The portioning container of claim 39, wherein the biodegradable fiber material includes no organic binders.

47. A portioning container constructed from biodegradable fiber material, the portioning container comprising:
a receptacle for holding a consumable, wherein the receptacle is manufactured, from the biodegradable fiber material, using a pulp as a liquid solution containing the biodegradable fiber material, wherein the receptacle is provided with a barrier layer system that provides a barrier against penetration of one or more of moisture, water, aromatic substances, flavoring agents, odorants, or non-food-grade substances; and
a cover for closing the receptacle to produce a sealed volume within the portioning container.

48. The portioning container of claim 47, wherein the receptacle is formed from a first molded part made of a first fiber material, and a second molded part made from a second, different fiber material.

49. The portioning container of claim 47, wherein the barrier layer system is applied to an inner surface of the receptacle.

50. The portioning container of claim 47, wherein the biodegradable fiber material has a liquid solution content of less than 10%.

51. The portioning container of claim 47, wherein the receptacle is shaped such that one or more wall surfaces of the receptacle have an angle of at least 3 degrees with respect to an axis of symmetry that is oriented perpendicularly to a bottom surface of the receptacle.

52. The portioning container of claim 47, wherein the receptacle includes a partition that divides the sealed volume into at least a first volume and a second volume, and wherein the cover includes at least one outlet for the consumable in the sealed volume.

53. The portioning container of claim 52, wherein the cover divides an incoming liquid flow into the sealed volume into at least a first liquid flow into the first volume and a second liquid flow into the second volume, and wherein a bottom surface of the portioning container includes at least one tap.

54. A molded part manufactured from biodegradable fiber material, the molded part comprising:
a receptacle for holding a consumable, wherein the receptacle is manufactured from the biodegradable fiber material;
a cover for closing the receptacle to produce a sealed volume within the molded part, wherein the cover is manufactured from the biodegradable fiber material; and
a barrier layer applied to an inner surface of the receptacle, wherein the barrier layer includes one or more of: a wax layer, a coating layer, a layer of PTFE, or a ceramic layer.

55. The molded part of claim 54, wherein the biodegradable fiber material does not include any organic or non-organic binders.

56. The molded part of claim 54, the receptacle is formed from a first molded part made of a first fiber material, and a second molded part made from a second, different fiber material.

57. The molded part of claim 54, wherein the molded part is a portioning container, and wherein the cover has a resealable tap.

58. The molded part of claim 54, wherein the molded part is a hot-beverage capsule, wherein the cover is configured to divide an incoming liquid flow into at least two liquid flows into two separate volumes within the sealed volume, and wherein a bottom surface of the hot-beverage capsule includes at least two separate taps.
